(19) United States
(12) Patent Application Publication
(10) Pub. No.: US 2017/0267431 A1
(43) Pub. Date: Sep. 21, 2017

(54) PACKAGING WITH AN ANTIBACTERIAL COATING

(71) Applicant: CLIFTON PACKAGING GROUP LIMITED, Leicester (GB)

(72) Inventors: Shahid Sheikh, Leicester (GB); Shane D'Souza, Leicester (GB)

(73) Assignee: CLIFTON PACKAGING GROUP LIMITED, LEICESTER (GB)

(21) Appl. No.: 15/611,225

(22) Filed: Jun. 1, 2017

Related U.S. Application Data
(63) Continuation-in-part of application No. 15/531,298.

(30) Foreign Application Priority Data
Nov. 28, 2014 (GB) 1421215.3

(51) Int. Cl. B65D 81/24; C09D 5/14; G01N 21/64; B05D 1/28; B05C 1/08; A01N 59/16; C09D 5/22

(52) U.S. Cl. CPC B65D 81/24; A01N 59/16; C09D 5/14; C09D 5/22; B05D 1/28; B05C 1/0834; G01N 21/643; G01N 2021/6439

(57) ABSTRACT

Packaging for storing and displaying raw wet protein portions is described. In particular, the packaging has: a housing for containing one or more portions of raw wet protein; an antibacterial coating on a surface of the housing; and a tracer indicating presence of the coating. A system and method for coating the packaging is disclosed as well as a method of detecting antibacterial food packaging.

### FIELD

The present disclosure describes packaging having a housing for storing and displaying raw wet protein portions. In particular, packaging having an antibacterial coating on a surface of the housing and, optionally, a tracer indicating presence of the coating is described.

### BACKGROUND

Contamination of food products by bacteria such as by Campylobacter is a known problem in food preparation and packaging industries. The issue is particularly relevant to food packaging industries for fresh food products such as wet protein products, including raw poultry. Whilst many measures are in place to reduce the risk of bacterial contamination, including the use of machine automation, anti-bacterial sprays, and anti-bacterial wipes, risks remain.

The sale of raw meat, in particular poultry, more particularly chicken, typically involves packaging made out of 3 components. A tray, such as a rigid plastic or polystyrene tray or container on which the meat is placed, a plastic film and a conventional wrap label are all required. Such packages are sometimes called tray lidded CAP (controlled atmosphere packaging) packs. Recently self-standing flexible pouches have been proposed as an alternative way of packaging raw wet protein portions GB2532797. In any case such packaging is typically sold in the chiller cabinets of supermarkets as a fresh product.

One area of concern is contamination of the exterior of food packaging by bacteria. This may be caused, for example, by the presence of small amounts of raw wet protein matter on the exterior of the packaging. Such contamination can occur during filling of the food packaging, or may occur at other stages of the packaging process. As an example, for tray lidded CAPs, these typically require manual handling during filling to ensure that the product is orientated the correct way in the packaging. Manual handling can cause cross contamination including transfer of uncooked meat juices or products to the outside of the tray, lid, conventional wrap, staff and all ancillary equipment. This risk is mitigated, but not eliminated with pouches, which may be prepared and filled with minimal handling.

The presence of such bacterial matter on the exterior of the food packaging can cause further cross contamination. For example, if the exterior of a fresh wet protein packaging is contaminated with bacteria, when bought by a consumer, the packaging can cross contaminate other food items and packaging into which the contaminated packaging has been brought into contact with. Additionally, contamination can occur in store or within shopping trolleys etc. Given that (in supermarket consumer trolleys in particular) such food packaging can be in close contact with foodstuffs intended for raw consumption, such as fruit and vegetables, and the risk of cross contamination becomes clear. As noted above, current measures such as antibacterial sprays and wipes do not fully solve the issue and may require additional stages in the production process, which is undesirable.

Furthermore, it is also, at present, difficult for a retailer to determine whether antibacterial measures have been applied to a product. This creates uncertainty for the retailer, particularly if they wish to promote the antibacterial measures, and also to manage their own product flow, holding conditions, etc. It is an object of the present disclosure to alleviate these issues.

### SUMMARY

According to a first aspect of the present disclosure, there is provided packaging for storing and displaying raw wet protein portions, said packaging comprising: a housing for containing one or more portions of raw wet protein; an antibacterial coating on a surface of the housing; and a tracer indicating presence of the coating.

The use of a tracer (also known as a taggant) provides a means of authenticating and testing for the presence of the antibacterial coating. The means is non-destructive and quick to test for and implement.

The antibacterial coating may be provided on an exterior surface of the housing. Additionally, the antibacterial coating may be provided on all exterior surfaces of the housing. The coating may optionally additionally or alternatively be provided to the inside surface of the pouch. Application to the outside of the packaging aids prevention of cross-contamination. The packaging may be either provided to a machine for filling with the antibacterial coating pre-applied (i.e. before filling of the packaging), or the coating may be applied to the filled packaging (for example by spraying or printing).

The antibacterial coating may be transparent. The antibacterial coating may comprise silver ions. The tracer may be a photosensitive tracer. The tracer may be sensitive to infra-red light. The tracer may be a luminescent tracer.

As noted, the tracer may be a photosensitive tracer that allows visual detection by a laser pen or a suitable detector.

For example, the tracer or taggant may be sensitive to infra-red light. This allows a detector to be used configured to detect the presence of or lack of presence of a response from the housing to infra-red light. In this manner, the detector may illuminate the housing with infra-red light having a particular wavelength, that may be narrowly defined, and detect reflection and/or absorption characteristics of the light.

The tracer may be combined with or intrinsic to the antibacterial coating. The tracer may be provided as a coating to the housing.

An example of the antibacterial coating includes coatings that may comprise silver ions. Other antibacterial coatings include chemical coatings such as triclosan containing coatings. It can be appreciated that the composition of the anti-bacterial coating can be selected based on the intended use and/or the expected bacterial contaminate. The antibacterial coating may comprise an antibacterial powder, a solvent for dissolving the powder and ensuring an even coverage of antibacterial coating on the housing, and a lacquer for protecting the coating and/or for ensuring that the antibacterial coating is impregnated in the housing.

In examples the antibacterial coating may comprise the tracer (also known as a taggant) indicating presence of the coating.

The tracer may be sensitive to exposure to variations in atmospheric conditions. The tracer may be sensitive to exposure to temperature variations. The tracer may further indicate exposure of the packaging to undesired conditions. Such tracer may be the same tracer used to identify the bacterial coating, or an additional tracer may be used.

Given that raw wet protein portions are typically required to be kept in refrigerated conditions, any temperature rises (or indeed temperature falls) can impact on the quality of the food stuffs contained within the packaging. By using a tracer sensitive to temperature fluctuations, said tracer may be used to indicate that the packaging has been exposed to sub-optimal temperatures, indicating potential risk to the consumer and/or retailer. This allows the retailer and/or the consumer to only purchase optimally temperature stored products.

Similarly, the tracer may be used to show that an altered atmosphere typically used within the housing to maintain the food stuffs, has been compromised. For example, the tracer may be altered by exposure to oxygen present within normal atmospheric conditions. This can be used to indicate damage to the packaging. In such instances, the tracer may be provided on an inside surface of the packaging, or it may be within a layer of a laminate structure.

In embodiments of the packaging, the tracer may be provided as a coating to the housing. Alternatively, the tracer may be combined with the antibacterial coating as an additive or may be intrinsic to the antibacterial coating (i.e. the antibacterial coating has properties that allow it to be used as a tracer, such as photo-sensitivity).

In embodiments, the tracer may be provided to the exterior of the housing. The tracer may be a luminescent tracer. The luminescent tracer may be configured to emit light when illuminated with light of a particular wavelength. The light may be of a particular frequency or wavelength. Alternatively or additionally, the tracer may be reflective and configured to reflect light of a particular wavelength.

Due to the nature of the raw wet protein portions within the housing, the packaging typically requires refrigeration and often an altered internal atmosphere. The composition of the altered internal atmosphere can be tailored to keep the wet protein portion in the best condition to prevent the wet protein from soiling in taste and/or appearance. The tracer may be configured to be sensitive to variations in either temperature and/or disruption to the altered internal atmosphere. For example, the tracer may provide an alternative response after exposure to soiling temperatures, or exposure to normal atmosphere. This way, the retailer and potentially the customer can be assured of the supply line and chain such that the packaging arrives to the consumer in the optimal condition.

The housing may be flexible. The housing may be a self-standing flexible pouch. The housing may further comprise a closure, said closure sealing the housing. The tracer may be used to indicate opening of the closure.

By self-standing, it is intended that the product is able to stand upright on a substantially flat surface such as a refrigerated display shelf without support. Such self-standing pouches are sometimes called self-supporting pouches or upstanding pouches. Typically, such self-standing pouches are taller than they are wide—this creates a pleasing appearance on display shelving (the appearance that they are standing upright).

For example, a packaging factory typically orders one pallet of plastic pouches or even a roll of plastic film if the pouches are made from the film on-site. The empty plastic pouches (if they are pre-formed/made elsewhere), or the roll of film, takes up far less space in the delivery lorry. The plastic pouches are typically lighter than a polystyrene tray. However a further advantage is that it is a more efficient use of the delivery logistics, and storage logistics, at the packaging factory to have plastic pouches. The pouches are normally formed from a single sheet of plastic folding, and sealed to itself.

Once purchased, the consumer can take the packaging home and open it—for example by cutting open the top. In some embodiments the opening of the closure allows the raw wet protein portion to be dispensed by upturning and squeezing the pouch. The consumer may then pour or squeeze the wet protein foodstuff out of the packet/pouch. This can avoid the user touching the chicken—some consumers do not like to touch wet raw wet protein portions. In other examples, the closure is integral with the pouch and is optionally a tearable portion of the pouch. Alternatively, the closure is a zipper for sealing the pouch. In such embodiments, the zipper allows the pouch to be resealed after opening. As noted above, opening the closure may affect the tracer, allowing a customer or retailer to determine if the packaging has been opened.

The housing may comprise a laminate having several layers. Examples include laminate films. The antibacterial coating may be provided onto one layer of the laminate. The tracer may be provided onto one layer of the laminate film.

Exemplary substrates for the housing include one or more plastics, such as polyethylene (PET) and its derivatives and/or polyester (CPP) and its derivatives. As noted, in embodiments, the packaging may be a laminated substrate. Said laminated substrate may be a laminate of two or more plastics, such as one or more layers of PET and one or more layers of CPP.

According to an example of the present disclosure, there is provided a system for applying a coating to a housing, typically a film, for sealing a wet protein food product, said system comprising: a plurality of cylinders for applying one or more coatings to the housing/film, wherein at least one of said coatings is an antibacterial coating.

At least one of said coatings may contain a tracer indicative of the presence of the antibacterial coating. Said coating may be a luminescent tracer or a photosensitive tracer as defined in relation to the above aspects.

The anti-bacterial coating may be applied by a sandwich printing technique. In one example, said cylinder for applying the antibacterial coating may be a gravure cylinder. In an alternative example, said cylinder for applying the antibacterial coating may be a flexo plate. Other printing techniques may be used to coat the housing with the antibacterial coating.

In examples, the antibacterial coating may be provided as an antibacterial solution in a reservoir such that the cylinder rotates within the reservoir to coat the cylinder with the antibacterial solution. The cylinder may then contact a surface of the housing to print or apply the antibacterial solution to the housing. The solution may be applied to the one or both surfaces of the housing.

In examples, the system may include a dryer for drying the applied antibacterial coating to the housing. Heat may be used. Additionally or alternatively, ultra-violet light may be used to cure the antibacterial coating.

According to another example of the present disclosure, there is provided a method for applying an antibacterial coating to a plastics housing, said method comprising the steps of: providing a reservoir containing an antibacterial solution; providing one or more cylinders for guiding the plastics film; submerging at least one cylinder within the reservoir to coat the exterior surface of the cylinder with the antibacterial solution; and guiding the plastics film over the exterior surface to coat a surface of the film with the antibacterial solution.

As described above, the method may further comprise drying or curing steps using heat from a heater or cured with light, such as ultra-violet light from a ultra-violet lamp.

The antibacterial coating may be applied as a separate process to printing of the housing with graphics or the like, film lamination or other processes. Such lamination and printing processes typically occur before the film is supplied to apply the antibacterial coating and optionally the tracer/taggant.

According to a further example of the present disclosure, there is provided packaging for storing and displaying raw wet protein portions, said packaging comprising: a tray for containing one or more portions of raw wet protein; and a film sealing the tray, wherein the film is provided with an antibacterial coating.

The film may comprise a tracer indicating presence of the coating.

In examples, the antibacterial coating may be provided to the exterior of the film. Applying the antibacterial coating to the exterior of the film helps to prevent cross contamination between the food product and other items that the food product may come into contact with.

Additionally or alternatively, the film and/or the coating may be transparent to allow the food product in the tray to be seen through the film. The film may be flow wrap, pouches or other suitable material, typically laminated plastics.

An example of the antibacterial coating includes coatings that may comprise silver ions. Other antibacterial coatings include chemical coatings such as triclosan containing coatings. It can be appreciated that the composition of the anti-bacterial coating can be selected based on the intended use and/or the expected bacterial contaminate. The antibacterial coating may comprise an antibacterial powder, a solvent for dissolving the powder and ensuring an even coverage of antibacterial coating on the film, and a lacquer for protecting the coating and/or for ensuring that the antibacterial coating is impregnated in the film.

In examples the antibacterial coating may comprise a tracer indicating presence of the coating. The use of a tracer or taggant provides a means of authenticating and testing for the presence of the antibacterial coating. The tracer may be a photosensitive tracer that allows visual detection by a laser pen or a suitable detector.

For example, the tracer or taggant may be sensitive to infra-red light. This allows a detector to be used configured to detect the presence of or lack of presence of a response from the film to infra-red light. In this manner, the detector may illuminate the film with infra-red light having a particular wavelength, that may be narrowly defined, and detect reflection and/or absorption characteristics of the light.

The tracer may be provided as a coating to the film. Alternatively, the tracer may be combined with the antibacterial coating as an additive or may be intrinsic to the antibacterial coating (i.e. the antibacterial coating has properties that allow it to be used as a tracer, such as photo-sensitivity).

The tracer may be provided to the exterior of the film. The tracer may be a luminescent tracer. The luminescent tracer may be configured to emit light when illuminated with light of a particular wavelength. The light may be of a particular frequency or wavelength. Alternatively or additionally, the tracer may be reflective and configured to reflect light of a particular wavelength.

Exemplary substrates include one or more plastics, such as polyethylene (PET) and its derivatives and/or polyester (CPP) and its derivatives. In embodiments, the film may be a laminated substrate. Said laminated substrate may be a laminate of two or more plastics, such as one or more layers of PET and one or more layers of CPP.

According to another example of the present disclosure, there is provided a method of detecting antibacterial food packaging, said method comprising the steps of: providing food packaging coated concomitantly with an antibacterial coating and a tracer coating; providing a reader for detecting presence of the tracer, wherein a positive reading indicates presence of the tracer.

It can be appreciated that the raw wet protein portion may consist mainly of raw wet protein in addition to associated products such as water. Sauces and/or marinades may also be added to the pouch to form part of the intended raw wet protein portion for consumption. The raw wet protein portion may be a poultry meat portion. For example, diced chicken, strips of chicken, or small chicken fillets. Other wet small piece raw protein foodstuff/solid foodstuffs may also be used, for example pork, lamb, venison, rabbit, minced meat, fish, shellfish, etc.

These and other aspects of the disclosure will be apparent from, and elucidated with reference to, the embodiments described hereinafter.

### BRIEF DESCRIPTION OF DRAWINGS

Embodiments will be described, by way of example only, with reference to the drawings, in which

FIG. 1A is a schematic of packaging having a film with an antibacterial coating according to an embodiment of the present disclosure;

FIG. 1B illustrates a sealed food product packaging according to an alternative embodiment of the present disclosure;

FIG. 1C illustrates an empty opened pouch of FIG. 1B according to an embodiment of the present disclosure

FIG. 2 is a cross-sectional schematic of an embodiment of a system for coating a housing with an antibacterial coating;

FIG. 3 is a cross-sectional schematic of an alternative embodiment of a system for coating a housing with an antibacterial coating;

FIG. 4A is a detector configured to detect the presence of a tracer indicating application of the antibacterial film for a film that does not have an antibacterial coating; and

FIG. 4B is a detector configured to detect the presence of a tracer indicating application of the antibacterial film for a film that does have an antibacterial coating.

It should be noted that the Figures are diagrammatic and not drawn to scale. Relative dimensions and proportions of parts of these Figures have been shown exaggerated or reduced in size, for the sake of clarity and convenience in the drawings. The same reference signs are generally used to refer to corresponding or similar feature in modified and different embodiments.

### DETAILED DESCRIPTION OF EMBODIMENTS

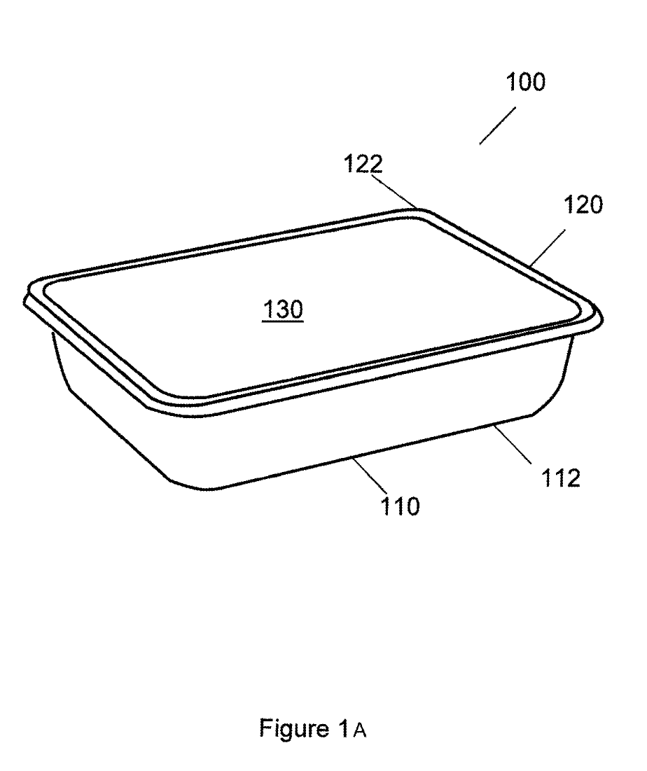

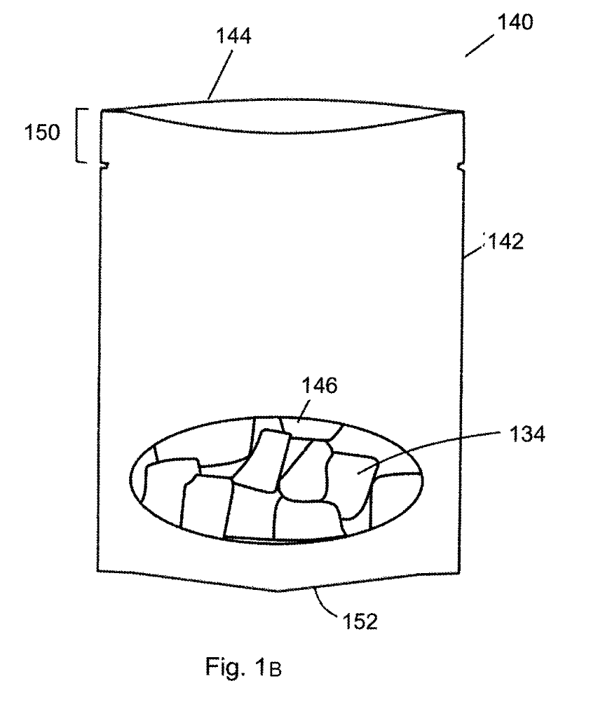

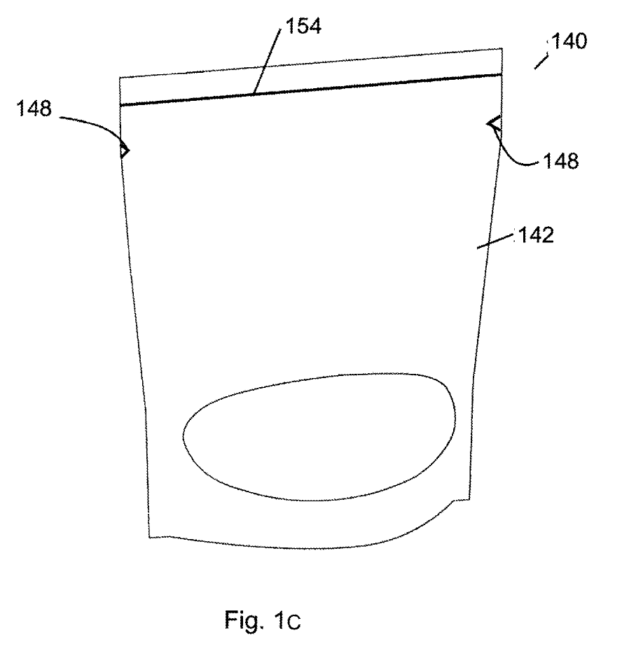

FIG. 1A shows packaging 100 for storing and presenting food stuffs, in particular for raw wet protein portions. The packaging comprises a tray 110 with a substantially flat bottomed portion 112 and a film 120 configured to form a closure to seal the tray 110. The film 120 is located against a lip 122 of the tray and is typically heat shrunk against the tray to melt the film 120 to the tray 110. The tray typically is used to contain and present raw wet protein food stuffs, such as poultry, more particularly chicken.

The film 120 is typically a laminate film (although a standard film may be used) and is made from a combination of one or more plastics, such as polyethylene (PET) and its derivatives and/or polyester (CPP) and its derivatives. The type and composition of the plastics used can be tailored to the required application. Some plastics are more suitable to heat shrinking, whilst others are better to print graphics and text to.

The film is treated with an antibacterial coating 130. The antibacterial coating 130 is typically a composition containing silver ions, although chemical compositions, such as triclosan, may be used. The antibacterial coating 130 ensures that any stray food stuffs from within the tray 110 and not sealed by the film 120, for example, contaminants during packaging of the food stuffs into the tray 110 prior to sealing, do not pose a bacterial contamination threat.

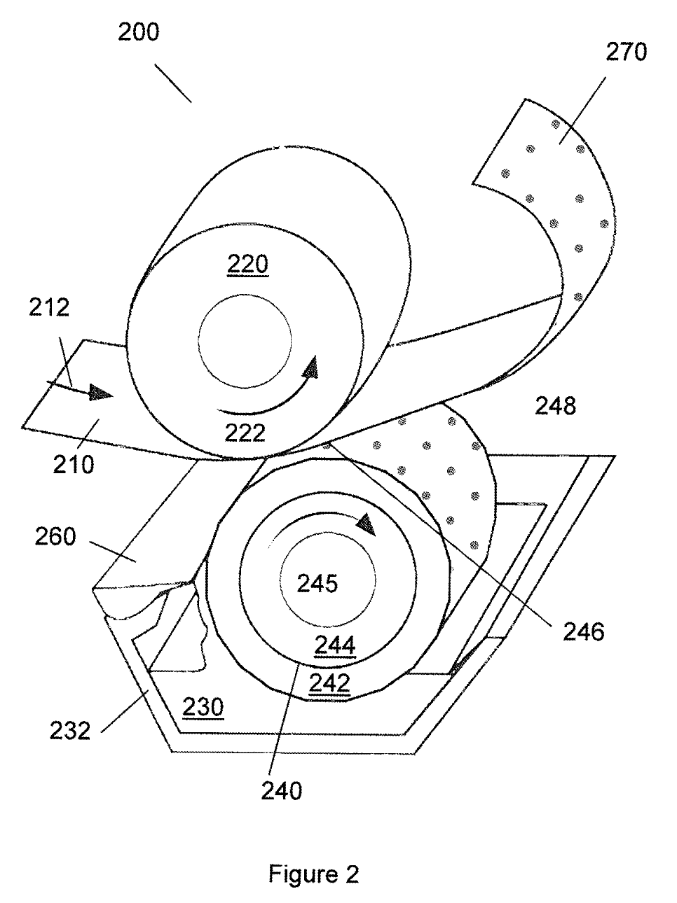

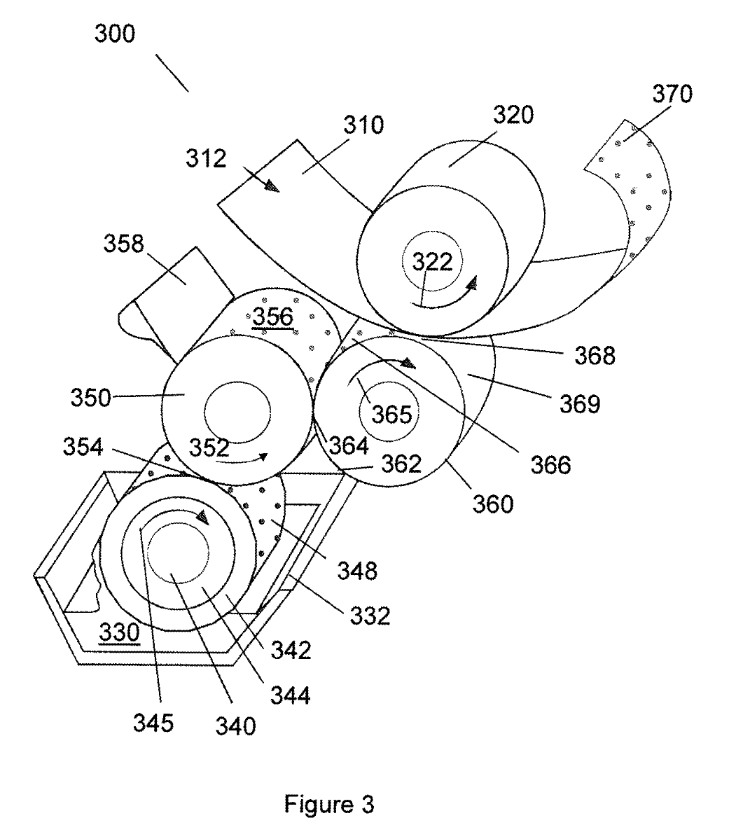

The antibacterial coating 130 is typically applied as will be described below in relation to FIGS. 2 and 3. The antibacterial coating 130 is typically a powder containing the antibacterial agent, which is combined with a solvent to dissolve the powder and to aid even coating when applied to a plastics film. In addition, a lacquer is typically used to ensure a smooth finish. The coating 130 is typically dried or cured onto the film 120 as will be described below.

Additionally, the antibacterial coating 130 can contain a tracer that acts as a marker to provide proof that the antibacterial coating 130 has been successfully applied to the film 120. Such tracers may be photosensitive compounds, such as reflective compounds configured to reflect light of a known wavelength, luminescent markers, or the like. For laminate films 120, the tracer may be applied to the same layer or side of the film 120 as the antibacterial coating 130, or it may be applied to different layers or sides. Additionally, the tracer may be combined with the antibacterial coating 130.

FIG. 1B shows an alternative embodiment of packaging for storing and presenting food stuffs, in particular for raw wet protein portions. FIG. 1B shows a food product 140 according to aspects of the present invention. The product 140 has a pouch 142 with an opening 144. The opening 144 allows access to the interior of the pouch 142 into which portions of raw wet protein portions 14 may be placed. The product 140 also has a transparent window or portion 146 through which the portions 14 can be viewed by a consumer. It can be appreciated that the size, transparency and presence of the transparent portion may be tailored for different food products. The product 140 also features a tear strip 148 that allows for removal of a top portion 150 of the pouch 142 after the pouch has been sealed, allowing access to the contents of the pouch 142.

The pouch 142 of the food product 140 is provided with a base portion 152 that is at least as wide as the opening 144. This allows the food product 140 to be self-supporting or upstanding so that it can be placed onto a shelf vertically, displaying the contents or labelling of the pouch 142 to a consumer. As shown, the pouch 142 is generally taller than its width and depth to create the illusion that the pouch 142 is standing whilst on display. The pouch 142 may be tapered, that is the opening 144 may be smaller than the base portion 152, but generally the opening 144 and base portion 152 are the same size.

The opening 144 is shown as running along the upper length of the pouch 142, however it can be appreciated that the opening may be smaller in size and only allow access across a portion of the upper surface 150 of the pouch 142. Additionally or alternatively, the opening 144 may be provided at least partially on the side wall of the pouch 142 to create a side or corner opening.

The pouch 142 is typically made from a laminate structure comprising several layers such as polypropylene contacting the raw wet protein portions and polyester as an outer layer to provide strength to the pouch and a printable surface. Barrier layers such as aluminum foil and abrasion resistance layers such as nylon may also be provided. This construction allows the pouch 142 to be flexible whilst self-standing or self-supporting. It also allows the pouch 142 to be flattened when empty.

FIG. 1C shows the food product 140 of FIG. 1B after the mouth or opening 144 of the pouch 142 has been sealed. In the example shown, the top portion 150 of the pouch 142 above the tear strip 148 has been heat sealed to bond the opening 144 closed. Accordingly, the closure 154 is integral with the pouch 142. It can be appreciated that other closures may be used including a zipper. Use of a zipper allows for resealing of the pouch 142 after opening. The pouch 142 is provided with an antibacterial coating (not shown) provided on the external surface of the pouch 142. Label information and graphical information can be printed directly onto the external surface of the pouch providing a cleaner and neater finished look to the product 140. Such information is provided vertically to allow consumers to view the information easily when the product is stacked vertically and self-standing on a shelf.

FIG. 2 shows an exemplary embodiment of a system 200 for applying an antibacterial coating 130 to a housing, typically a film 210 for application on either a tray or for manufacture into pouches. It can be appreciated that the film 210 may have been processed in printing and/or lamination systems and processes prior to being provided to the system 200.

The general process is a gravure printing system. The film 210 is passed through the system 200 in the direction shown 212 by an impression cylinder 220 rotating in an anticlockwise direction 222 (in this example). Concomitantly, a gravure cylinder 240 is immersed within a reservoir 232 in which an antibacterial solution 230 is provided. Rotation of the gravure cylinder 240 collects antibacterial solution 230 into the surface 242 of the gravure cylinder 240. The surface 242 becomes impregnated with antibacterial solution 230. A doctor blade 260 removes excess solution 230 from the surface 242 and returns it to the reservoir 232. A core 244 coupled to a drive mechanism rotates the surface 242 in the direction shown 245. The gravure cylinder 240 and the impression cylinder 220 are configured to meet at point 246. Due to the relative movement between the cylinders 220, 240 and the saturation of antibacterial solution 230 in the surface 242 as shown by 248, the lower surface 270 of the film 210 is coated with the antibacterial solution as it is passed through the system 200.

An alternative mechanism and system 300 is shown in FIG. 3. Like references are used for like parts of FIG. 2. FIG. 3 depicts a flexo coating process. A central impression chamber 320 receives a film 310 and drives the film 310 through the system 300. It can be appreciated that the film 210 may have been processed in printing and/or lamination systems and processes prior to being provided to the system 200. Like FIG. 2, a reservoir 332 contains antibacterial solution 330 and a pick-up roller 340, with surface 342 and core 344. The roller 340 is immersed within the reservoir 332 and rotates 345 to coat and saturate the surface 342 with the antibacterial solution 330 as shown in 348.

The antibacterial solution is transferred to an anilox roller 350 via contact point 354. The anilox roller rotates 352 and contacts and transfers the antibacterial solution on its surface 356 to the surface 362, 366 of a flexo plate 360 via contact point 364 as the two rollers 350, 360 rotate relative to each other. Excess antibacterial solution on the surface 356 is removed by a doctor blade 358.

The flexo plate 360 rotates 365 and antibacterial solution present on the surface 366 of the flexo plate 360 is transferred to the surface 370 of the film 310 via contact point 368 as the film 310 is fed through the system 300. After coating, the surface 369 of the flexo plate 360 is substantially free of antibacterial coating.

Once applied to the film 210, 310 by either system 200, 300, dryers and/or curing equipment can dry/cure the coated surface 270, 370. Heat can be used as a drying agent and ultra-violet light as a curing agent.

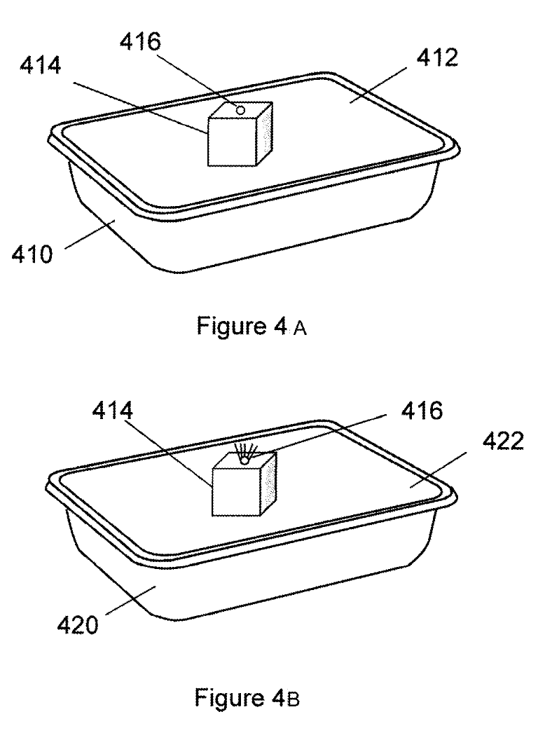

As noted above, the antibacterial solution 240, 340 may contain a tracer compound. Alternatively, a tracer compound may be coated onto the surface of the film 210, 310 in a similar manner to that used to coat the surfaces of the film 210, 310 with antibacterial solution. A detector can be used to indicate the presence of the tracer compound. An example is shown in FIG. 4A, 4B.

FIG. 4A shows a tray 410 with a film 412 that has not been coated with the antibacterial or tracer coatings. For this example, the tracer is considered to be within the antibacterial coating. When a detector 414 is placed on the film 412, no signal is emitted by the indicator 416. This result indicates that no antibacterial coating is present because no tracer compound has been detected by the detector.

FIG. 4B shows an alternative tray 420 that has a film 422 which has been coated with the antibacterial and tracer coating. Upon placing of the detector 414 onto the surface of the film 422, the indicator 416 lights, providing an indication that the antibacterial coating is present.

The detector 414 typically operates by emitting a light of a known wavelength onto the film and detecting the presence (or absence) of transmission of the light. The wavelength may be a tightly defined wavelength, such as infra-red light. A positive result is provided if the tracer is present in the coating of the film, i.e. if the tracer transmits the emitted light back to the detector 414. Photosensitive or luminescent tracers may be used, with the detector 414 configured accordingly. A laser pen may be used with some tracer/taggant coatings, wherein visual detection is possible by analysing the reflection characteristics.

Although FIGS. 4A and 4B show a tray with a film, it can be appreciated that a similar test and result can be undertaken for other packaging, such as pouches, having an antibacterial coating on a surface of the pouch and a tracer indicating presence of the coating.

From reading the present disclosure, other variations and modifications will be apparent to the skilled person. Such variations and modifications may involve equivalent and other features which are already known in the art of, and which may be used instead of, or in addition to, features already described herein. For example, although wireless signals are typically referred to, the skilled person would appreciate the application of the present disclosure to non-wireless signals, particularly those that utilise interleaving.

Although the appended claims are directed to particular combinations of features, it should be understood that the scope of the disclosure of the present invention also includes any novel feature or any novel combination of features disclosed herein either explicitly or implicitly or any generalisation thereof, whether or not it relates to the same invention as presently claimed in any claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The applicant hereby gives notice that new claims may be formulated to such features and/or combinations of such features during the prosecution of the present application or of any further application derived therefrom.

For the sake of completeness it is also stated that the term “comprising” does not exclude other elements or steps, the term “a” or “an” does not exclude a plurality, a single processor or other unit may fulfil the functions of several means recited in the claims and reference signs in the claims shall not be construed as limiting the scope of the claims.

1. Packaging for storing and displaying raw wet protein portions, said packaging comprising:
a housing for containing one or more portions of raw wet protein;
an antibacterial coating on a surface of the housing; and
a tracer indicating presence of the coating.

2. Packaging according to claim 1, wherein the antibacterial coating is provided on an exterior surface of the housing.

3. Packaging according to claim 2, wherein the antibacterial coating is provided on all exterior surfaces of the housing.

4. Packaging according to claim 1, wherein the coating is transparent.

5. Packaging according to claim 1, wherein the antibacterial coating comprises silver ions.

6. Packaging according to claim 1, wherein the tracer is a photosensitive tracer.

7. Packaging according to claim 1, wherein the tracer is sensitive to infra-red light.

8. Packaging according to claim 1, wherein the tracer is a luminescent tracer.

9. Packaging according to claim 1, wherein the tracer is combined with or intrinsic to the antibacterial coating.

10. Packaging according to claim 1, wherein the tracer is provided as a coating to the housing.

11. Packaging according to claim 1, wherein the tracer is sensitive to exposure to variations in atmospheric conditions.

12. Packaging according to claim 1, wherein the tracer is sensitive to exposure to temperature variations.

13. Packaging according to claim 1, wherein the housing is a self-standing flexible pouch.

14. Packaging according to claim 1, further comprising a closure, said closure sealing the housing wherein the tracer indicates opening of the closure.

15. Packaging according to claim 1, wherein the housing comprises a laminate having several layers and the antibacterial coating is provided onto one or more layer of the laminate.

16. Packaging according to claim 15, wherein the tracer is provided onto one or more layer of the laminate.

17. A method of detecting antibacterial food packaging, said method comprising the steps of:
providing packaging according to any preceding claim;
providing a reader for detecting presence of the tracer, wherein a positive indication of presence of the tracer indicates presence of the antibacterial coating.

18. A system for applying a coating to a housing for sealing a wet protein food product, said system comprising: a plurality of cylinders for applying one or more coatings to the housing, said one or more coating comprising an antibacterial coating and a tracer indicating the presence of the antibacterial coating.

19. A method for applying an antibacterial coating to a plastics housing, said method comprising:
providing a reservoir containing an antibacterial solution;
providing one or more cylinders for guiding the plastics film;
submerging at least one cylinder within the reservoir to coat the exterior surface of the cylinder with the antibacterial solution; and
guiding the plastics film over the exterior surface to coat a surface of the film with the antibacterial solution.
